(19) United States
(12) Patent Application Publication
(10) Pub. No.: US 2026/0236226 A1
(43) Pub. Date: Aug. 13, 2026

(54) ARITHMETIC CIRCUIT, ARITHMETIC METHOD, AND METHOD OF CONNECTING PROCESSING ELEMENT IN ARITHMETIC CIRCUIT

(71) Applicant: Fujitsu Limited, Kawasaki-shi (JP)

(72) Inventors: Makiko ITO, Kawasaki (JP); Yutaka TAMIYA, Yokohama (JP); Kentaro KAWAKAMI, Kawasaki (JP)

(73) Assignee: Fujitsu Limited, Kawasaki-shi (JP)

(21) Appl. No.: 19/534,053

(22) Filed: Feb. 9, 2026

(30) Foreign Application Priority Data
Feb. 10, 2025 (JP) 2025-020108

(51) Int. Cl. G06F 7/483; G06F 17/16

(52) U.S. Cl. CPC G06F 7/483; G06F 17/16

(57) ABSTRACT

An arithmetic circuit including: multiple processing elements arranged in a lattice; a first bus connecting a second processing element located downstream in a column-direction data flow to a first processing element; a second bus connecting a third processing element located downstream in a row-direction data flow to the first processing element; a third bus connecting a fourth processing element positioned upstream in the same row as the second processing element to the first processing element; and a fourth bus connecting a fifth processing element positioned downstream in the same row as the second processing element to the first processing element.

### CROSS-REFERENCE TO RELATED APPLICATION

This application is based upon and claims the benefit of priority of the prior Japanese Patent application No. 2025-20108, filed on February 10, 2025, the entire contents of which are incorporated herein by reference.

### FIELD

Embodiments relate to an arithmetic circuit, an arithmetic method, and a method of connecting a processing element in an arithmetic circuit.

### BACKGROUND

High-performance matrix operation accelerators have been used for artificial intelligence (AI) processing. In addition, with accelerated evolution of AI in recent years, there has been a demand for faster matrix operation performance for the accelerators.

As a method of efficiently processing matrix operations, an accelerator using a matrix operation unit of a systolic array type is known (Patent Document 1 and the like).

In the matrix operation unit of a systolic array type, a plurality of processing elements (processing elements (PE)) is arranged in a lattice pattern, and parallel operations are performed by causing data to flow into this plurality of PEs in a pipeline manner.

In the matrix operation unit of the systolic array type, there are advantages that satisfactory area efficiency is achieved since data communication locally occurs and that the plurality of PEs is easily integrated because of the single structure.

For example, related arts are disclosed in US Patent Application Publication No. 2022/0391695, Japanese Laid-open Patent Publication No.2008-34953, Japanese National Publication of International Patent Application No. 2018-527679, and US Patent Application Publication No. 2021/0081354.

### SUMMARY

According to an aspect of the embodiment, an arithmetic circuit including: a plurality of processing elements that are arranged in a lattice pattern; a first bus that connects, to a first processing element from among the plurality of processing elements, a second processing element that is adjacent to the first processing element on a downstream side in a data flow direction in a column direction; a second bus that connects a third processing element that is adjacent to the first processing element on a downstream side in a data flow direction in a row direction to the first processing element; a third bus that connects a fourth processing element that forms a same row as the second processing element and is arranged on a side further upstream than the second processing element in the data flow direction in the row direction to the first processing element; and a fourth bus that connects a fifth processing element that forms a same row as the second processing element and is arranged on a side further downstream than the second processing element in the data flow direction in the row direction to the first processing element.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating, as an example, a configuration of an accelerator according to a first embodiment;

FIG. 2 is a diagram illustrating, as an example, a connection configuration among PEs in the accelerator according to the first embodiment;

FIG. 3 is a diagram illustrating, as an example, a configuration of each PE in the accelerator according to the first embodiment;

FIG. 4 is a diagram illustrating a connection configuration among the PEs used in a case where the accelerator according to the first embodiment is caused to operate in a matrix operation mode;

FIG. 5 is a diagram illustrating a configuration that functions in each PE in the case where the accelerator according to the first embodiment is caused to operate in the matrix operation mode;

FIG. 6 is a diagram illustrating a connection configuration among the PEs used in a case where the accelerator according to the first embodiment is caused to operate in a CGRA mode;

FIG. 7 is a diagram illustrating a configuration that functions in each PE in the case where the accelerator according to the first embodiment is caused to operate in the CGRA mode;

FIG. 8 is a diagram for explaining a configuration of an accelerator according to a modification of the first embodiment;

FIG. 9 is a diagram for explaining a configuration of each PE in the accelerator according to the modification of the first embodiment;

FIG. 10 is a diagram illustrating, for each application, an optimal arrangement of high-functionality PEs in the accelerator;

FIG. 11 is a diagram illustrating, as an example, a configuration of an accelerator according to a second embodiment;

FIG. 12 is a diagram illustrating, as an example, a connection configuration among PEs in the accelerator according to the second embodiment;

FIG. 13 is a diagram illustrating, as an example, a configuration of each PE in the accelerator according to the second embodiment;

FIG. 14 is a diagram illustrating a bus used in a matrix operation mode in each PE in the accelerator according to the second embodiment;

FIG. 15 is a diagram illustrating a bus used in a CGRA vertical mode in each PE in the accelerator according to the second embodiment;

FIG. 16 is a diagram illustrating a bus used in a CGRA lateral mode in each PE in the accelerator according to the second embodiment;

FIG. 17 is a diagram for explaining a configuration of an accelerator according to a modification of the second embodiment; and

FIG. 18 is a diagram for explaining a configuration of each PE in the accelerator according to the modification of the second embodiment.

### DESCRIPTION OF EMBODIMENTS

However, since the matrix operation accelerators are specialized in matrix operations, it is not possible to achieve an increase in speed of processing related to non-matrix operations such as normalization and activation using matrix product results in a case where the matrix operation accelerators are used for acceleration of AI processing. Note that the normalization and the activation are combinations, or the like, of operations of nonlinear functions using vector data having a large number of elements as inputs.

Hereinafter, embodiments related to an arithmetic circuit, an arithmetic method, and a method of connecting a processing element in an arithmetic circuit will be described with reference to the drawings. However, the embodiments described below are merely examples, and there is no intention to exclude applications of various modifications and techniques that are not explicitly described in the embodiments. In other words, each embodiment can be variously modified (by combining embodiments and each modification or the like) and implemented without departing from the gist thereof. Each drawing is not intended to mean that only components illustrated in the drawing are included, and other functions and the like can be included.

### (I) Description of First Embodiment

### (A) Overview

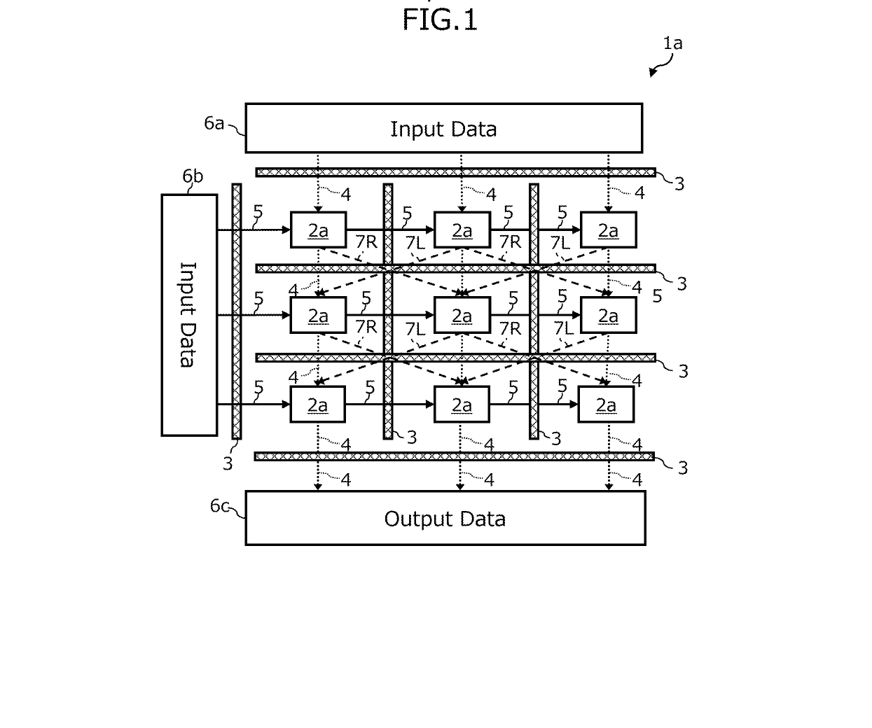

FIG. 1 is a diagram illustrating, as an example, a configuration of an accelerator 1a according to a first embodiment.

The accelerator 1a is a hardware accelerator having a function of performing calculation and is, for example, a processing element connected to a host computer, which is not illustrated. The host computer may be, for example, a high performance computing (HPC) or may be a personal computer, and can be implemented in various modifications.

The host computer causes the accelerator 1a to perform calculation by issuing commands for providing instructions to execute the calculation for the accelerator 1a. The host computer receives calculation results from the accelerator 1a.

In addition, the host computer may cause the accelerator 1a to perform circuit reconfiguration as needed. For example, the host computer transmits a command for causing the accelerator 1a to perform circuit reconfiguration. The host computer may transmit, together with this command, information (which may be referred to as configuration information) for setting a circuit configuration of each PE 2a which is a programmable circuit in order to perform the circuit reconfiguration of the accelerator 1a.

The accelerator 1a includes a plurality of PEs 2a (processing elements). Each PE 2a is a processing element that performs calculation. The plurality of PEs 2a is aligned in each of a row direction and a column direction by being arranged in a two-dimensional lattice pattern. Hereinafter, the left-and-right arrangement of the plurality of PEs 2a on the paper surface corresponds to a row, and the up-and-down arrangement on the paper surface corresponds to a column in the drawings. The plurality of PEs 2a arranged in the two-dimensional lattice pattern may be referred to as a PE group.

In the accelerator 1a, the PE group has a function as a pipelined coarse grained reconfigurable architecture (CGRA) and a function as a matrix multiplication unit. A state where the PE group is caused to function as the pipelined CGRA may be referred to as a CGRA mode, and a state where the PE group is caused to function as a matrix multiplication unit may be referred to as a matrix operation mode.

In the accelerator 1a illustrated as an example in FIG. 1, a plurality of (nine in the example illustrated in FIG. 1) PEs 2a is arranged in a lattice pattern (matrix pattern) of 3 rows × 3 columns.

In the drawing, the upper side in the column direction (vertical direction) is defined as an upstream side of a data flow, and the lower side is defined as a downstream side of the data flow. Also, the left side in the row direction (left-right direction) is defined as an upstream side of the data flow, and the right side is defined as a downstream side of the data flow.

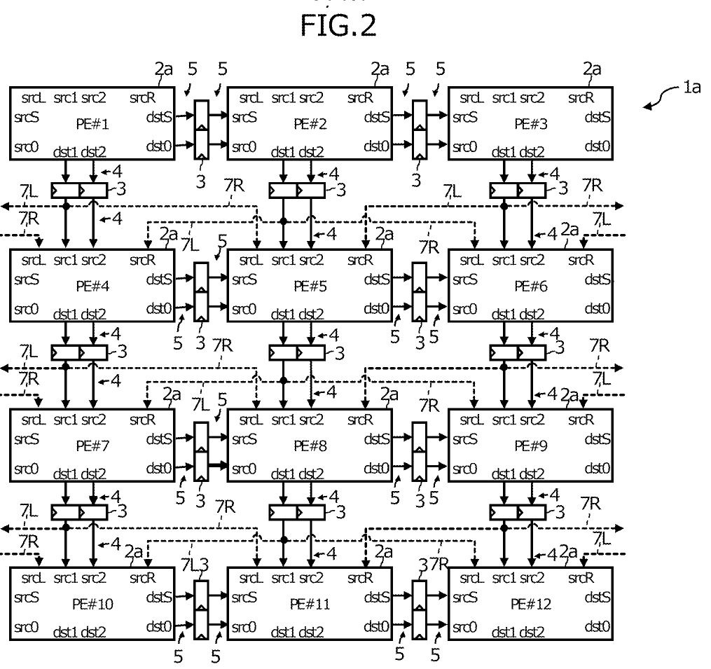

A pipeline register 3 (see FIG. 2) is arranged on each of the upstream side and the downstream side of each PE 2a, and data input to each PE 2a and data output from each PE 2a are temporarily stored in the pipeline register 3.

In the example illustrated in FIG. 1, three PEs 2a arranged to be aligned in the column direction (the vertical direction in FIG. 1) in the PE group are cascade-connected by a bus (wiring) 4, and three PEs 2a arranged to be aligned in the row direction (the lateral direction in FIG. 1) are cascade-connected by a bus 5.

In a case where the PE group is configured to function as a matrix multiplication unit, a first matrix of input data is input from the left end of the two-dimensional lattice, and a second matrix of the input data is input from the upper end of the two-dimensional lattice, for example, to the plurality of PEs 2a (PE group) arranged in the two-dimensional lattice pattern. In other words, the accelerator 1a has a circuit configuration that puts data from the upper side in the column direction and accelerates the matrix operation as a systolic array.

Each PE 2a receives data (calculation results) from adjacent upstream PEs 2a via the bus 4 and input data via the bus 5, and performs calculation. The calculation results and the input data are delivered to the adjacent downstream PEs 2a via the buses 4 and 5, respectively.

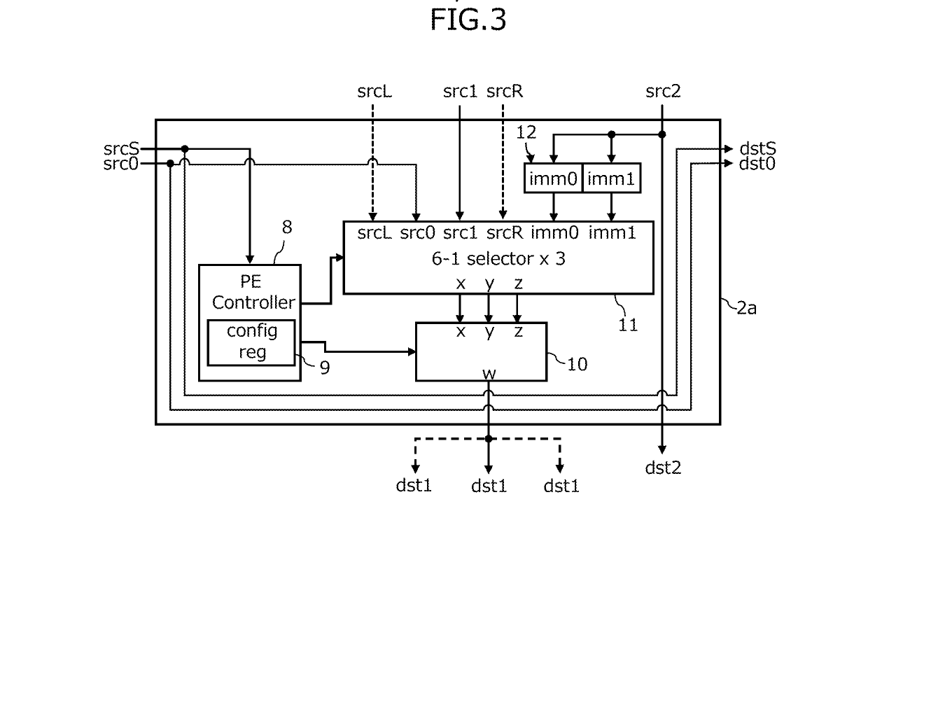

A configuration path, which is not illustrated, is connected to each PE 2a. The configuration path transmits configuration information for setting the circuit configuration of each PE which is a programmable circuit. In the individual PEs 2a, the configuration information received via the configuration path is stored in a configuration register 9 (FIG. 3) of a PE controller 8 (see FIG. 3) provided in each PE 2a. In each PE 2a, circuit reconfiguration is performed on the basis of the configuration information stored in the configuration register 9, and an operation (calculation content) of each PE 2a is thus appropriately switched. Each PE 2a may perform a different operation (calculation). Each PE 2a may be a processing element that performs an arithmetic and logic unit (ALU) operation. The accelerator 1a is an accelerator characterized by a coarse-granularity reconfigurable circuit that can be dynamically reconfigured using the ALU operation or the like as a basic element.

Each PE 2a receives data (calculation results) from adjacent upstream PEs 2a via the bus 4 and performs calculation in a case of an operation in the CGRA mode. Results of the calculation (calculation result) executed in the PEs 2a are delivered to the adjacent downstream PEs 2a via the bus 4 and the pipeline register 3.

Timing adjustment blocks 6a and 6b are hardware that adjusts an input timing of matrix elements to the PE group.

The timing adjustment block 6a adjusts an input timing of input data (first matrix) to the plurality of PEs 2a. In the matrix operation mode, the timing adjustment block 6a performs adjustment such that the input data is input at a timing at which data arrives from the timing adjustment block 6b via the pipeline register 3.

The timing adjustment block 6b adjusts an input timing of the input data (second matrix) to the PE group. In the matrix operation mode, the timing adjustment block 6b performs adjustment such that the input data is input at a timing at which data arrives from the timing adjustment block 6a via the pipeline register 3.

On the other hand, in the CGRA mode, the timing adjustment block 6a performs adjustment such that the input data is input at the same timing to each PE 2a constituting the first row (the uppermost row on the paper in the example illustrated in FIG. 1) in the PE group.

In the PE group of the accelerator 1a, each PE 2a is connected via the bus 4 to a downstream PE 2a in a cascade manner, and also one or more other PEs 2a that belong to the same row as the downstream PE 2a in the column direction.

In the example illustrated in FIG. 1, each PE 2a is connected via the bus 4 to a downstream PE 2a in the column direction, and to two additional PEs 2a that are in the same row and adjacent to the downstream PE 2a.

Note that in the PE group, a PE 2a that is adjacent to an arbitrary PE 2a on the downstream side (the lower side in FIG. 1) in the column direction of the PE 2a may be referred to as a lower adjacent PE 2a. The lower adjacent PE 2a is connected to the arbitrary PE 2a via the bus 4.

In addition, a PE 2a that belongs to the same row as the lower adjacent PE2a of the arbitrary PE2a and is adjacent to the lower adjacent PE2a on the upstream side (the left side in FIG. 1) in the row direction may be referred to as a left lower adjacent PE2a. In addition, a PE 2a that belongs to the same row as the lower adjacent PE2a of the arbitrary PE2a and is adjacent to the lower adjacent PE2a on the downstream side (the right side in FIG. 1) in the row direction may be referred to as a right lower adjacent PE2a.

In the accelerator 1a, each PE 2a is connected via a bus 7L to the left lower adjacent PE 2a, and via a bus 7R to the right lower adjacent PE 2a.

In other words, in the accelerator 1a, in a PE group in which the plurality of PEs 2a are arranged in the two-dimensional lattice, diagonally adjacent PEs 2a are connected via the buses 7L and 7R.

Furthermore, each PE 2a is configured to be capable of performing multiplication, addition/subtraction, and bit operations in addition to multiply-add operations, on the basis of the configuration information.

Thus, the PE group can also be caused to function as a pipelined CGRA in the accelerator 1a. In other words, the accelerator 1a functions as a pipelined dynamic reconfigurable circuit that has a simple circuit configuration and has a flow from top to bottom in the column direction as suitable for high-speed operations. Therefore, the accelerator 1a has a configuration obtained by combining a configuration as a pipelined dynamic reconfigurable circuit that has a simple circuit configuration and has a flow from top to bottom in the column direction as suitable for high-speed operations and a configuration in which data is put from the top in the column direction and matrix operations are accelerated as a systolic array.

A memory 6c is arranged on the downstream side of the PE group in the column direction. Results of operations performed in the PEs 2a aligned in the column direction in the PE group are input to the memory 6c as output data from each of the PEs 2a belong to the last row (the lowermost line on the paper in the example illustrated in FIG. 1) in the PE group.

### (B) Configuration

FIG. 2 is a diagram illustrating, as an example, a connection configuration among PEs 2a in the accelerator 1a according to the first embodiment.

The accelerator 1a illustrated as an example in FIG. 2 includes twelve PEs 2a, and these twelve PEs 2a are arranged in a lattice pattern of 4 rows × 3 columns. In addition, these twelve PEs 2a are identified by being denoted by any one of reference signs #1 to #12.

In the PE group formed by these twelve PEs 2a, #1, #4, #7, and #10 are set for the four PEs 2a belong to the first column (the leftmost column on the paper in the example illustrated in FIG. 2) in order from the upstream side to the downstream side in the column direction. These PEs 2a may be represented as a PE #1, a PE #4, a PE #7, and a PE #10.

In addition, #2, #5, #8, and #11 are set for the four PEs 2a that belong to the second column in the PE group in order from the upstream side to the downstream side in the column direction. These PEs 2a may be represented as a PE #2, a PE #5, a PE #8, and a PE #11.

Furthermore, #3, #6, #9, and #12 are set for the four PEs 2a belong to the last column (the rightmost column on the paper in the example illustrated in FIG. 2) in order from the upstream side to the downstream side in the column direction. These PEs 2a may be represented as a PE #3, a PE #6, a PE #9, and a PE #12.

Each PE 2a has inputs src0, src1, src2, srcS, srcL and srcR, respectively. In addition, each PE 2a has outputs dst0, dst1, dst2, and dstS.

The output dst0 is connected to the input src0 of the PE 2a on the downstream side (the right side in the example illustrated in FIG. 2) in the row direction via the pipeline register 3 and the bus 5.

The output dst2 is connected to the input src2 of the PE 2a on the downstream side (the lower side in the example illustrated in FIG. 2) in the column direction via the pipeline register 3 and the bus 4.

The output dstS is connected to the input srcS of the PE 2a on the downstream side (the right side in the example illustrated in FIG. 2) in the row direction via the pipeline register 3 and the bus 5.

The output dst1 is connected to the input src1 of the PE 2a (the lower adjacent PE 2a) on the downstream side (the lower side in the example illustrated in FIG. 2) in the column direction via the pipeline register 3 and the bus 4.

When the PE #5, for example, is focused on in the example illustrated in FIG. 2, the output dst1 of the PE #5 is connected to the input src1 of the PE #8 (lower adjacent PE 2a) via the pipeline register 3 and the bus 4.

In addition, the output dst1 is connected via the pipeline register 3 and the bus 7L to the input srcR of the left lower adjacent PE 2a that belongs to the same row as the lower adjacent PE 2a and is located on the upstream side in the row direction.

In the example illustrated in FIG. 2, for example, the output dst1 of the PE #5 is connected via the pipeline register 3 and the bus 7L to the input srcR of the PE #7 (left lower adjacent PE 2a) that is adjacent to the PE #8 (lower adjacent PE 2a) on the upstream side in the row direction.

Furthermore, the output dst1 is connected via the pipeline register 3 and the bus 7R to the input srcL of the right lower adjacent PE 2a that belongs to the same row as the lower adjacent PE 2a and is located on the downstream side in the row direction.

In the example illustrated in FIG. 2, for example, the output dst1 of the PE #5 is connected via the pipeline register 3 and the bus 7R to the input srcL of the PE #9 (right lower adjacent PE 2a) that is adjacent to the PE #8 (lower adjacent PE 2a) on the downstream side in the row direction.

The output dst0 of the PE 2a on the upstream side (the left side in the example illustrated in FIG. 2) in the row direction is connected to the input src0 via the pipeline register 3 and the bus 5.

The output dst1 of the PE 2a on the upstream side (the upper side in the example illustrated in FIG. 2) in the column direction is connected to the input src1 via the pipeline register 3 and the bus 4.

The output dst2 of the PE 2a on the upstream side (the upper side in the example illustrated in FIG. 2) in the column direction is connected to the input src2 via the pipeline register 3 and the bus 4.

The output dstS of the PE 2a on the upstream side (the left side in the example illustrated in FIG. 2) in the row direction is connected to the input srcS via the pipeline register 3 and the bus 5.

The input srcL of PE 2a (hereinafter referred to as the host PE 2a) is connected via the pipeline register 3 and the bus 7R to the output dst1 of the left upper adjacent PE 2a, which belongs to the same row as the upper adjacent PE 2a and is located on the upstream side in the row direction. The upper adjacent PE 2a is positioned on the upstream side in the column direction relative to the host PE 2a.

In the example illustrated in FIG. 2, for example, the input srcL of the PE #5 is connected via the pipeline register 3 and the bus 7R to the output dst1 of the PE #1 (left upper adjacent PE 2a) that is adjacent to the PE #2 (upper adjacent PE 2a) on the upstream side in the row direction.

The input srcR of host PE 2a is connected via the pipeline register 3 and the bus 7L to the output dst1 of the right upper adjacent PE 2a, which belongs to the same row as the upper adjacent PE 2a and is located on the downstream side in the row direction.

In the example illustrated in FIG. 2, for example, the input srcR of the PE #5 is connected to the output dst1 of the PE #3 (right upper adjacent PE 2a) that is adjacent to the PE #2 (upper adjacent PE 2a) on the downstream side in the row direction via the pipeline register 3 and the bus 7L.

The bus 4 is an example of a first bus that connects, to the PE #5 (first processing element) among the plurality of PEs 2a, the PE #8 (third processing element) that is adjacent to the PE #5 on the downstream side in a data flow direction in the column direction.

In addition, the bus 7L is an example of a third bus that connects the PE #5 (first processing element) to the PE #7 (fourth processing element) that forms the same row as the PE #8 (second processing element) and is arranged on the side further upstream than the PE #8 (second processing element) in the data flow direction in the row direction.

In addition, the bus 7R is an example of a fourth bus that connects the PE #5 (first processing element) to the PE #9 (fifth processing element) that forms the same row as the PE #8 (second processing element) and is arranged on the side further downstream than the PE #8 (second processing element) in the data flow direction in the row direction.

In other words, the bus 4 connects the PE #2 that is adjacent to the PE #5 (first processing element), from among the plurality of PEs 2a, on the upstream side in the data flow direction in the column direction to the PE #5.

In addition, the bus 7L connects the PE #3 that forms the same row as the PE #2 and is arranged on the side further downstream than the PE #2 in the data flow direction in the row direction to the PE #5 (first processing element).

Furthermore, the bus 7R connects the PE #1 that forms the same row as the PE #2 and is arranged on the side further upstream than the PE #2 in the data flow direction in the row direction to the PE #5 (first processing element).

It is possible to state that the buses 4, 5, 7L, and 7R are connected by the PE controller 8 causing each PE 2a to implement the circuit configuration on the basis of the configuration information stored in the configuration register 9. In other words, the PE controller 8 performs connection between the PEs 2a in the accelerator 1a.

FIG. 3 is a diagram illustrating, as an example, a configuration of each PE 2a in the accelerator 1a according to a first embodiment.

As illustrated in FIG. 3, each PE 2a includes a PE controller 8, a calculation unit 10, a selector 11, and an immediate register 12.

srcS input to the PE 2a is input to the PE controller 8 and is output to the downstream PE 2a as dstS. src0 input to the PE 2a is input to the selector 11 and is output to the downstream PE 2a as dst0. srcL, src1, and srcR input to the PE 2a are input to the selector 11. src2 input to the PE 2a is input to the immediate register 12 and is output to the downstream PE 2a as dst2.

The immediate register 12 is a register that stores immediate values and has a double-buffer configuration including two storage areas. src2 is input to the immediate register 12. The input src2 may be alternately stored in the two storage areas in the immediate register 12. The two immediate values stored in the immediate register 12 will be represented as imm0 and imm1. Each of imm0 and imm1 is input to the selector 11. Hereinafter, in a case where imm0 and imm1 are not particularly distinguished, imm0and imm1 will be represented as imm.

The selector 11 is a six-input three-output selector circuit having six inputs and three outputs. The selector 11 may be configured by combining three selector six-input one-output selector circuits (6-1 selectors) each having six inputs and one output. srcL, src0, src1, srcR, imm0, and imm1 are input to the selector 11, and three selected from these six inputs according to control by the PE controller 8 are output. The three outputs of the selector 11 are defined as x, y, and z. Each of the outputs x, y, and z of the selector 11 is input to the calculation unit 10.

The calculation unit 10 performs calculation using the inputs x, y, and z from the selector 11 according to the control by the PE controller 8. In the matrix operation mode, the calculation unit 10 performs fused multiply-add (FMA) operations. In the CGRA mode, the calculation unit 10 may execute any of FMA, multiplication, addition/subtraction, and bit operations according to the control by the PE controller 8.

A calculation result w obtained by the calculation unit 10 is output as dst1 from the PE 2a. Note that in the accelerator 1a illustrated as an example in FIG. 2, dst1 is input to, in addition to the lower adjacent PE 2a, the left lower adjacent PE 2a and the right lower adjacent PE 2a in the CGRA mode.

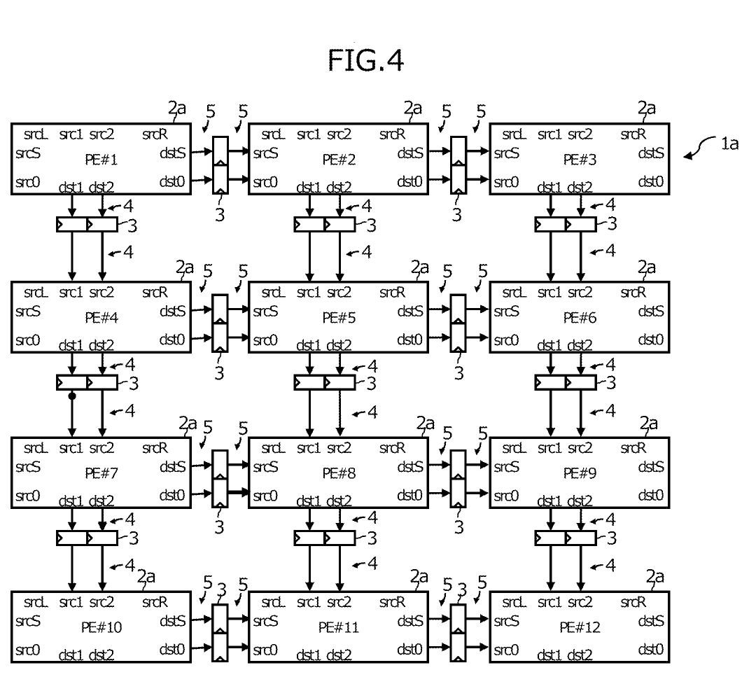

FIG. 4 is a diagram illustrating a connection configuration among the PEs 2a used in a case where the accelerator 1a according to the first embodiment is caused to operate in the matrix operation mode.

As illustrated in FIG. 4, the PEs 2a are connected via the buses 4 and 5 in the matrix operation mode. Specifically, in the row direction, dstS of the upstream PE 2a is connected to srcS of the downstream PE 2a via the bus 5 and the pipeline register 3, and dst0 of the upstream PE 2a is connected to src0 of the downstream PE 2a via the bus 5 and the pipeline register 3.

In the column direction, dst1 of the upstream PE 2a is connected to src1 of the downstream PE 2a via the bus 4 and the pipeline register 3, and dst2 of the upstream PE 2a is connected to src2 of the downstream PE 2a via the bus 4 and the pipeline register 3.

In other words, in a case where the accelerator 1a is used for a matrix operation (matrix operation mode), data is transmitted among the plurality of PEs 2a using the bus 4 (first bus). In other words, data transmitted among the plurality of PEs 2a via the bus 4 (first bus) is used for the matrix operation.

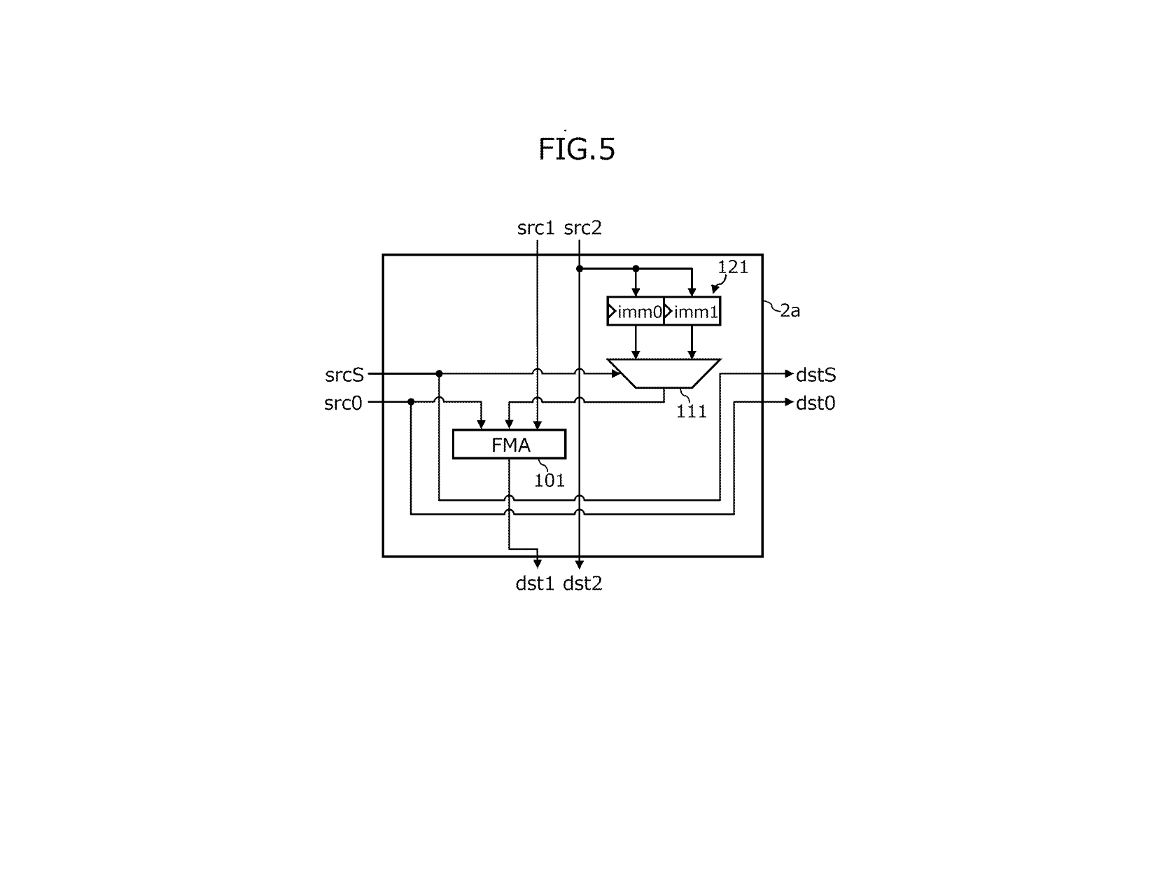

FIG. 5 is a diagram illustrating a configuration that functions in each PE 2a in the case where the accelerator 1a according to the first embodiment is caused to operate in the matrix operation mode.

As illustrated in FIG. 5, the PE 2a functions as an FMA calculation unit 101, a two-input selector 111, and an immediate register 121 in the matrix operation mode. In the matrix operation mode, src0, src1, src2, and srcS are input to the PE 2a, and dst0, dst1, dst2, and dstS are output.

Note that src0 input to the PE 2a is output as dst0, srcS input to the PE 2a is output as dstS, and src2 input to the PE 2a is output as dst2.

The immediate register 121 is a register that stores immediate values and has a double-buffer configuration including two storage areas. src2 is input to the immediate register 121. The input src2 may be alternately stored in the two storage areas in the immediate register 12. The two immediate values stored in the immediate register 121 will be represented as imm0 and imm1. As the immediate register 121, the immediate register 12 described above is used.

To the two-input selector 111, imm0 and imm1 in the immediate register 121 and the selection signal srcS are input, and one of imm0 and imm1 is switched in accordance with srcS, is then output, and is input to the FMA calculation unit 101.

To the FMA calculation unit 101, src0, src1, and imm (imm0, imm1) output from the two-input selector 111 are input, and an FMA operation (dst1 = imm * src0 + src1) is performed by using these values. The calculation result is output as dst1.

As described above, the accelerator 1a includes the configuration as a systolic array type matrix calculator, and in the matrix operation mode, a matrix operation can be accelerated by using the configuration as the systolic array type matrix calculator.

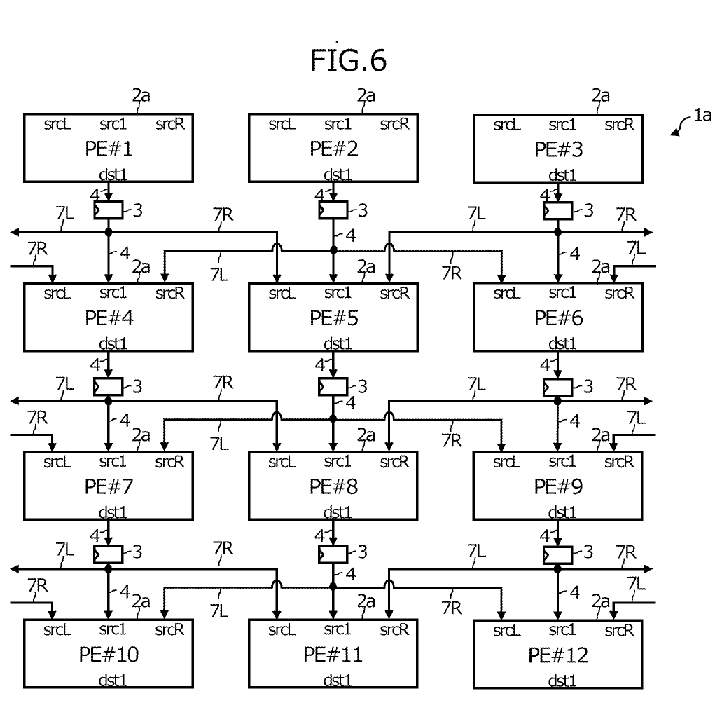

FIG. 6 is a diagram illustrating a connection configuration among the PEs 2a used in a case where the accelerator 1a according to the first embodiment is caused to operate in the CGRA mode.

As illustrated in FIG. 6, the PEs 2a are connected via the buses 4, 7L, and 7R in the CGRA mode.

Specifically, in the column direction, dst1 of each PE 2a is connected to src1 of the PE 2a on the downstream side thereof via the bus 4 and the pipeline register 3.

In addition, dst1 of each PE 2a is connected to the input srcR of the lower left adjacent PE 2a via the pipeline register 3 and the bus 7L, and is connected to the input srcL of the lower right adjacent PE 2a via the pipeline register 3 and the bus 7R.

In other words, in a case where the accelerator 1a is used for a non-matrix operation (CGRA mode), data is transmitted among the plurality of PEs 2a using the bus 7L (third bus) and the bus 7R (fourth bus). In other words, data transmitted among the plurality of PEs 2a via the bus 7L (third bus) and the bus 7R (fourth bus) is used for the non-matrix operation.

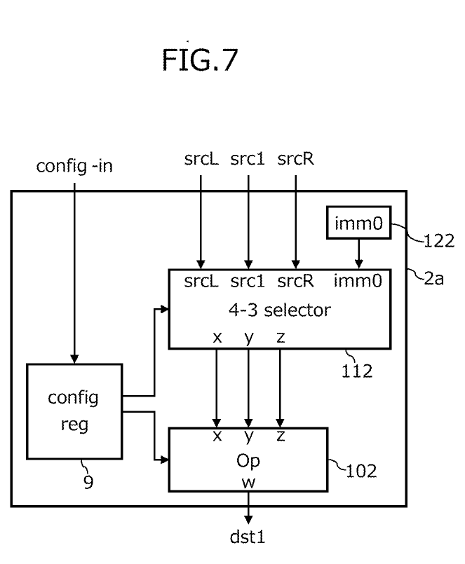

FIG. 7 is a diagram illustrating a configuration that functions in each PE 2a in the case where the accelerator 1a according to the first embodiment is caused to operate in the CGRA mode.

As illustrated in FIG. 7, the PE 2a functions as the configuration register 9, a calculation unit 102, a selector 112, and a constant register 122 in the CGRA mode. In the CGRA mode, config-in, src1, srcL, and srcR are input to the PE 2a, and dst1 is output.

The constant register 122 is a register that stores constants. In the example illustrated in FIG. 7, the constant register 122 stores imm0 as a constant. The constant imm0 in the constant register 122 is input to the selector 112.

The selector 112 is a 4-input 3-output selector, and src1, srcL, and srcR and imm0 in the constant register 122 are input thereto. The selector 112 may be configured by combining three four-input one-output selector circuits (4-1 selectors) each having four inputs and one output. The selector 112 selects and outputs three values from src1, srcL, srcR, and imm0 according to values stored in a predetermined area of the configuration register 9. The three values selected from src1, srcL, srcR and imm0 may overlap, and, the three values may be selected to at least partially overlap, for example, two src1 and one srcL may be selected. The three outputs will be represented as x, y, and z. The outputs x, y, and z from the selector 112 are input to the calculation unit 102.

To the calculation unit 102, x, y, and z output from the selector 112 are input, and any one of FMA, multiplication, addition/subtraction, and a bit operation is executed using these values according to the values stored in the predetermined area of the configuration register 9. The calculation result is output as dst1.

As described above, the accelerator 1a also includes a pipelined CGRA, and in the CGRA mode, a non-matrix operation (multiplication, addition/subtraction, a bit operation) can be accelerated by using the configuration as the pipelined CGRA.

### (C) Actions and Effects

In a case where the accelerator 1a according to the first embodiment configured as described above is caused to execute a matrix operation, a host computer transmits the configuration information for causing the PE group to function as a matrix calculator to the accelerator 1a via the configuration path.

In each PE 2a, the configuration information received via the configuration path is stored in the configuration register 9 of the PE controller 8. In each PE 2a, circuit (see FIG. 5) reconfiguration for performing the matrix operation is performed on the basis of the configuration information stored in the configuration register 9. As a result, the accelerator 1a is configured as a systolic array type matrix calculator.

In the timing adjustment block 6a, a first matrix for the plurality of PEs 2a of the PE group is stored as input data, and in the timing adjustment block 6b, a second matrix for the plurality of PEs 2a of the PE group is stored as input data. In the PE group, a matrix operation is executed on these pieces of input data. As a result, the accelerator 1a can realize acceleration of the matrix operation in the matrix operation mode.

In a case where the accelerator 1a is caused to execute a non-matrix operation (FMA, multiplication, addition/subtraction, a bit operation, or the like), the host computer transmits configuration information for causing the PE group to function as the pipelined CGRA to the accelerator 1a via the configuration path.

In each PE 2a, the configuration information received via the configuration path is stored in the configuration register 9 of the PE controller 8. In each PE 2a, circuit (see FIG. 7) reconfiguration for performing the non-matrix operation is performed on the basis of the configuration information stored in the configuration register 9. As a result, the accelerator 1a is configured as a pipelined CGRA.

Data input to the plurality of PEs 2a of the PE group is stored in the timing adjustment block 6a, and the PE group executes a non-matrix operation (FMA, multiplication, addition/subtraction, a bit operation) on the input data. As a result, the accelerator 1a can realize acceleration of the non-matrix operation in the CGRA mode.

Therefore, the accelerator 1a can accelerate both the matrix operation and the non-matrix operation and can improve calculation performance.

In the accelerator 1a, each PE 2a of the PE group is connected to, in addition to the column-direction downstream PE 2a cascade-connected via the bus 4, two PEs 2a (the left lower adjacent PE 2a and the right lower adjacent PE 2a) that belong to the same row as the downstream PE 2a and are adjacent to the downstream PE 2a via the buses 7L and 7R.

In the CGRA mode, the calculation unit 102 executes a non-matrix operation (FMA, multiplication, addition/subtraction, a bit operation) using the values x, y, and z output from the selector 112 according to the values stored in the predetermined area of the configuration register 9.

As a result, it is possible to cause the accelerator 1a to function as the pipelined CGRA and to accelerate the non-matrix operation (FMA, multiplication, addition/subtraction, a bit operation).

### (II) Description of Modification of First Embodiment

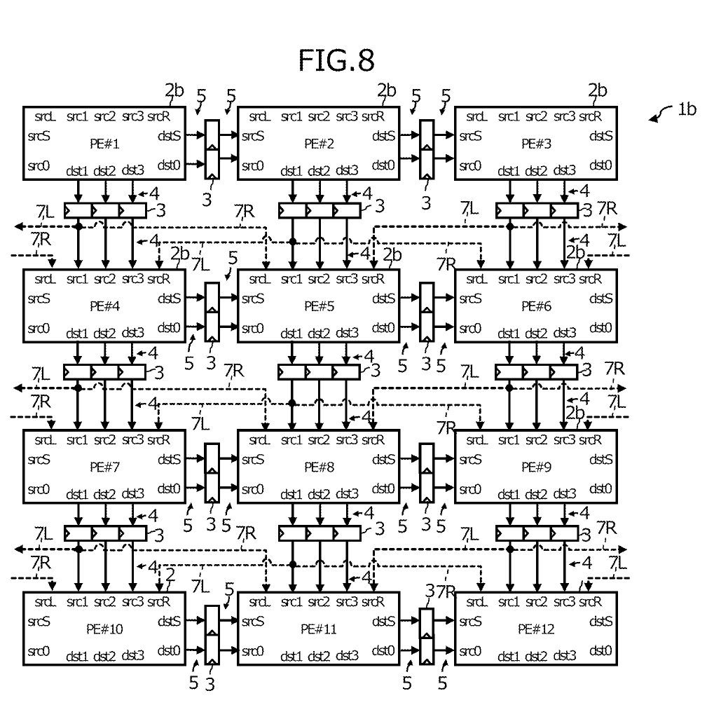

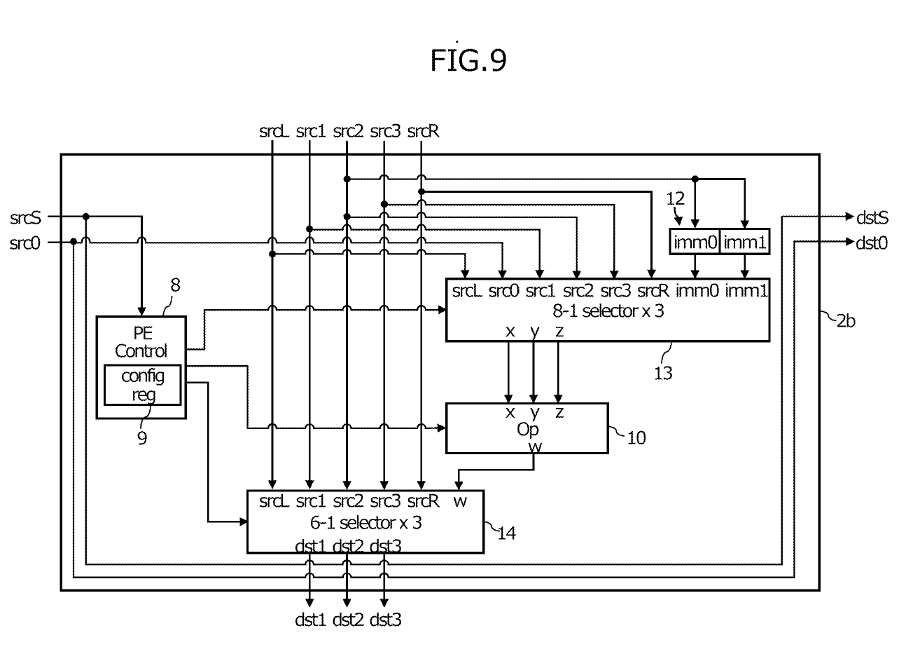

FIGS. 8 and 9 are diagrams for explaining a configuration of an accelerator 1b as a modification of the first embodiment. FIG. 8 is a diagram illustrating, as an example, a connection configuration among PEs 2b of the accelerator 1b as the modification of the first embodiment, and FIG. 9 is a diagram illustrating, as an example, a configuration of each PE 2b of the accelerator 1b as the modification of the first embodiment.

In the accelerator 1b illustrated in FIG. 8, a wiring (path) of each of src3 and dst3 is added in addition to the connection configuration of the accelerator 1a of the first embodiment illustrated in FIG. 2.

Hereinafter, since the reference signs that are the same as the above-described reference signs denote similar parts in the drawings, the description thereof will be omitted.

An output dst3 is connected to an input src3 of the PE 2b (lower adjacent PE 2b) on the downstream side (the lower side in the example illustrated in FIG. 8) in the column direction via a pipeline register 3 and a bus 4.

An output dst3 of the PE 2b on the upstream side (the upper side in the example illustrated in FIG. 8) in the column direction is connected to the input src3 via the pipeline register 3 and the bus 4.

As illustrated in FIG. 9, each PE 2b includes a PE controller 8, a calculation unit 10, selectors 13 and 14, and an immediate register 12.

srcS input to the PE 2b is input to the PE controller 8 and is output to the downstream PE 2b as dstS. src0 input to the PE 2b is input to the selector 13 and is output to the downstream PE 2b as dst0.

srcL, src1, srcR, and src3 input to the PE 2b are input to each of the selector 13 and the selector 14. src2 input to the PE 2b is input to the immediate register 12 and is input to each of the selector 13 and the selector 14. src2 is input to the immediate register 12 and is stored as immediate values imm0 and imm1.

The selector 13 is an eight-input three-output selector circuit having eight inputs and three outputs. The selector 13 may be configured by combining three eight-input one-output selector circuits (8-1 selectors) each having eight inputs and one output. srcL, src0, src1, src2, src3, srcR, imm0, and imm1 are input to the selector 13, and three selected from these eight inputs according to control by the PE controller 8, are output. The three outputs of the selector 13 are defined as x, y, and z. Each of the outputs x, y, and z of the selector 13 is input to the calculation unit 10.

The calculation unit 10 performs calculation using the inputs x, y, and z from the selector 13 according to the control by the PE controller 8. In the matrix operation mode, the calculation unit 10 performs fused multiply-add (FMA) operations. In the CGRA mode, the calculation unit 10 may execute any of FMA, multiplication, addition/subtraction, and bit operations according to the control by the PE controller 8. A calculation result w of the calculation unit 10 is input to the selector 14.

The selector 14 is a six-input three-output selector circuit having six inputs and three outputs. The selector 14 may be configured by combining three six-input one-output selector circuits (6-1 selectors) each having six inputs and one output. srcL, src1, src2, src3, srcR, and the output w of the calculation unit 10 are input to the selector 14, and three selected from these six inputs according to control by the PE controller 8 are output. The three outputs of the selector 14 are defined as dst1, dst2, and dst3. Each of the outputs dst1, dst2, and dst3 of the selector 14 is output from the PE 2b.

Note that in the accelerator 1b illustrated as an example in FIG. 8, dst1 out of these outputs dst1, dst2, and dst3 is input to, in addition to the lower adjacent PE 2b, the left lower adjacent PE 2b and the right lower adjacent PE 2b in the CGRA mode.

As described above, according to the accelerator 1b as the modification of the first embodiment configured as described above, it is possible to obtain the same actions and effects as those in the first embodiment and to take advantage of the src2 and dst2 buses as data transfer paths in the CGRA mode. In addition, it is possible to further increase the data transfer paths (transfer paths) by adding the src3 and dst3 buses.

As a result, it is possible to expand the range of mappable applications and to achieve an effect that automatic mapping by a compiler is facilitated.

### (III) Description of Second Embodiment

### (A) Overview

In CGRA, each PE often performs simple operations such as FMA, multiplication, addition/subtraction, and bit operations. On the other hand, many PEs are needed for complicated calculation such as nonlinear functions.

Here, the number of PEs to be used can be reduced by making the PEs highly functional. The number of terms in polynomial approximation or the like can be reduced by adding a look up table (LUT) to the PEs and referring to the table for an initial approximation value, for example. In addition, it is also possible to cause the PEs to have frequently occurring calculation itself such as exponential functions as a function by making the PEs highly functional. Hereinafter, the highly functionalized PEs may be referred to as a high-functionality PEs.

However, since the high-functionality PEs lead to a large circuit area, it is difficult to have all the PEs in the accelerator as high-functionality PEs, and there is a need to partially arrange high-functionality PEs in the accelerator. Also, optimal arrangement of the high-functionality PEs in the accelerator differs depending on an application.

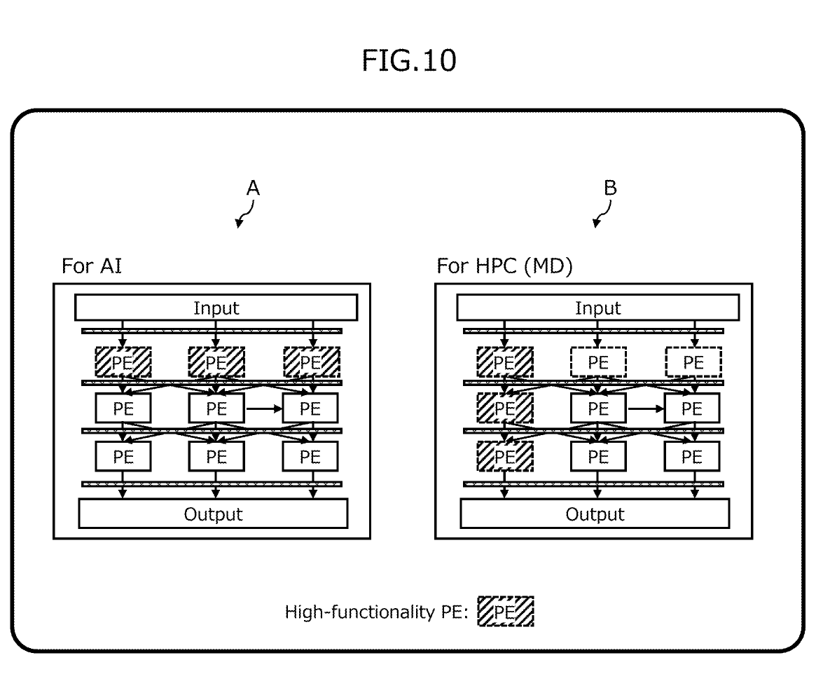

FIG. 10 is a diagram illustrating, for each application, an optimal arrangement of the high-functionality PEs in the accelerator. In FIG. 10, the reference sign A denotes a configuration of an accelerator suitable for AI as an example, and the reference sign B denotes a configuration of an accelerator suitable for the HPC field such as molecular dynamics (MD) simulation as an example.

In the accelerator for AI, independent processing is performed for each column, and LUT access frequency per process is low. Therefore, in the accelerator for AI, it is possible to efficiently execute the data processing by arranging the high-functionality PEs at constant intervals in the direction (the row direction; the left-right direction in FIG. 10) orthogonal to the pipeline direction (column direction) as indicated by the reference sign A in FIG. 10.

On the other hand, in the accelerator for HPC, collective data processing is performed in units of columns. Furthermore, continuous reference to the LUT occurs, for example, reference to the LUT is further performed using a LUT reference result as an address. Therefore, in the accelerator for HPC, it is possible to efficiently execute the data processing by arranging the high-functionality PEs at constant intervals along the pipeline direction (column direction) as indicated by the reference sign B in FIG. 10.

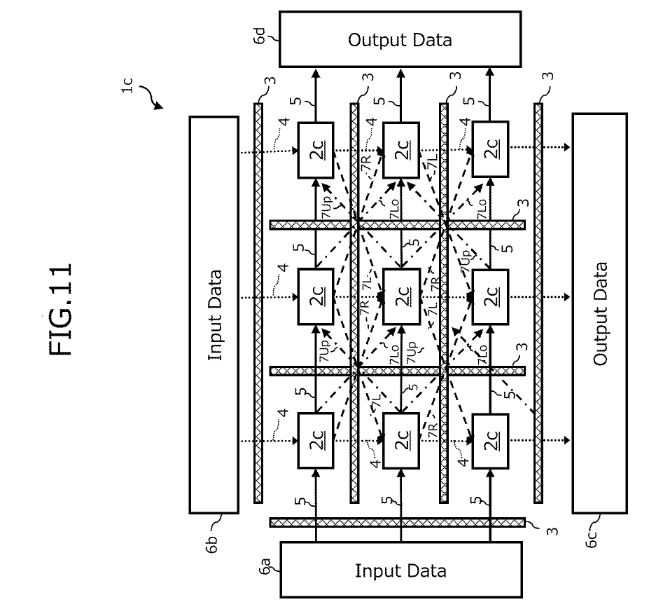

FIG. 11 is a diagram illustrating, as an example, a configuration of an accelerator 1c according to a second embodiment.

In a PE group of the accelerator 1c of the second embodiment, it is desirable that, in at least one row, two or more of the PEs 2c constituting the row be high-functionality PEs. The high-functionality PEs may have higher functionality than the other PEs 2c. For example, the high-functionality PEs may be configured to perform operations more complex than ALU operations, or may be special high-functionality PEs having a table.

The accelerator 1c illustrated in FIG. 11 includes PE 2c instead of the PEs 2a of the accelerator 1a illustrated as an example in FIG. 1. Furthermore, in the PE group of the accelerator 1c, each PE 2c is connected to, in addition to the downstream PE 2c cascade-connected by the bus 5, one or more other PEs 2c belong to the same column as the downstream PEs 2c on the downstream side in the row direction.

The bus 5 is an example of a second bus that connects to a PE 2c (second processing element) that is adjacent to the first PE 2c (first processing element) from among the plurality of PEs 2c (processing elements) on the downstream side in the data flow direction in the row direction with respect to this PE 2c (first processing element).

In the example illustrated in FIG. 11, each PE 2c is connected to, in addition to the row-direction downstream PE 2c cascade-connected by the bus 5, two PEs 2c that belong to the same column as the downstream PE 2c and are adjacent to the downstream PE 2c.

Note that in the PE group, a PE 2c that is adjacent to an arbitrary PE 2c on the downstream side (the right side in FIG. 11) in the row direction of the PE 2c may be referred to as a right adjacent PE 2c. The right adjacent PE 2c is connected to the arbitrary PE 2c via the bus 5.

In addition, a PE 2c that belongs to the same column as the right adjacent PE 2c with respect to the arbitrary PE 2c and is adjacent to the right adjacent PE 2c on the upstream side (the upper side in FIG. 11) in the column direction may be referred to as a right upper adjacent PE 2c. In addition, a PE 2c that belongs to the same column as the right adjacent PE 2c with respect to the arbitrary PE 2c and is adjacent to the right adjacent PE 2c on the downstream side (the lower side in FIG. 11) in the column direction may be referred to as a right lower adjacent PE 2c.

Note that the right lower adjacent PE 2c with respect to the arbitrary PE 2c in the accelerator 1c of the second embodiment illustrated as an example in FIG. 11 has the same positional relationship as that of the right lower adjacent PE 2a with respect to the arbitrary PE 2a in the accelerator 1a of the first embodiment illustrated as an example in FIG. 1.

In the accelerator 1c, each PE 2c is connected to the right upper adjacent PE 2c via a bus 7Up, and each PE 2c is connected to the right lower adjacent PE 2c via a bus 7Lo.

In other words, in the accelerator 1c, the PEs 2c that are adjacent to each other in diagonal directions via the buses 7L, 7R, 7Up, and 7Lo are connected to each other in the PE group in which the plurality of PEs 2c are arranged in a two-dimensional lattice pattern.

Furthermore, each PE 2c is configured to be capable of executing multiplication, addition/subtraction, and bit operations in addition to multiply-add operations, on the basis of the configuration information.

Thus, the PE group can also be caused to function as a pipelined CGRA in the accelerator 1c.

In addition, in the accelerator 1c of the second embodiment, it is possible to execute calculation by switching a CGRA vertical mode in which calculation is performed by the PE group sending data in the column direction and a CGRA lateral mode in which calculation is performed by the PE group sending data in the row direction when the PE group is caused to function as the pipelined CGRA.

The non-matrix operation executed in the CGRA vertical mode may be referred to as a first non-matrix operation. Further, the non-matrix operation executed in the CGRA lateral mode may be referred to as a second non-matrix operation. A memory 6c is arranged on the downstream side of the PE group in the column direction. Results of calculation performed in order in the PEs 2c aligned in the column direction in the PE group are input from each of the PEs 2c belong to the last row (the lowest line on the paper in the example illustrated in FIG. 1) in the PE group to the memory 6c as output data.

A memory 6d is arranged on the downstream side of the PE group in the row direction. Results of calculation performed in each of the PEs 2c aligned in the row direction in the PE group are input from each of the PEs 2c that belong to the last column (the rightmost column on the paper in the example illustrated in FIG. 11) in the PE group to the memory 6d as output data.

### (B) Configuration

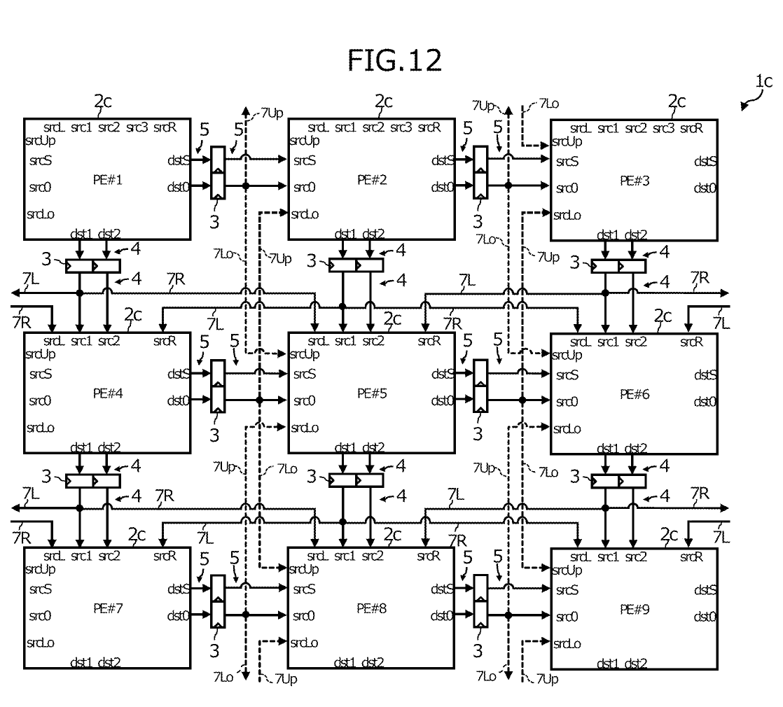

FIG. 12 is a diagram illustrating, as an example, a connection configuration among the PEs 2c in the accelerator 1c according to the second embodiment.

The accelerator 1c illustrated as an example in FIG. 12 includes nine PEs 2c, and these nine PEs 2c are arranged in a lattice pattern of 3 rows × 3 columns. In addition, these nine PEs 2c are identified by being denoted by any one of reference signs #1 to #9.

In the PE group formed by these nine PEs 2c, #1, #4, and #7 are set for the three PEs 2c constituting the first column (the leftmost column on the paper in the example illustrated in FIG. 12) in order from the upstream side to the downstream side in the column direction. These PEs 2c may be represented as a PE #1, a PE #4, and a PE #7.

In addition, #2, #5, and #8 are set for the three PEs 2c that belong to the second column in the PE group in order from the upstream side to the downstream side in the column direction. These PEs 2c may be represented as a PE #2, a PE #5, and a PE #8.

Furthermore, #3, #6, and #9 are set for the three PEs 2c that belong to the last column (the rightmost column on the paper in the example illustrated in FIG. 12) in order from the upstream side to the downstream side in the column direction. These PEs 2c may be represented as a PE #3, a PE #6, and a PE #9.

Each PE 2c has inputs src0, src1, src2, srcS, srcL, srcR, srcUp, and srcLo. In addition, each PE 2c has outputs dst0, dst1, dst2, and dstS.

The output dst2 is connected to the input src2 of the PE 2c on the downstream side (the lower side in the example illustrated in FIG. 12) in the column direction via the pipeline register 3 and the bus 4.

The output dstS is connected to the input srcS of the PE 2c on the downstream side (the right side in the example illustrated in FIG. 12) in the row direction via the pipeline register 3 and the bus 5.

The output dst1 is connected to the input src1 of the PE 2c (the lower adjacent PE 2c) on the downstream side (the lower side in the example illustrated in FIG. 12) in the column direction via the pipeline register 3 and the bus 4.

When the PE #5, for example, is focused on in the example illustrated in FIG. 12, the output dst1 of the PE #5 is connected to the input src1 of the PE #8 (lower adjacent PE 2c) via the pipeline register 3 and the bus 4.

In addition, the output dst1 is connected via the pipeline register 3 and the bus 7L to the input srcR of the left lower adjacent PE 2c that belongs to the same row as the lower adjacent PE 2c and is located on the upstream side in the row direction.

In the example illustrated in FIG. 12, for example, the output dst1 of the PE #5 is connected via the pipeline register 3 and the bus 7L to the input srcR of the PE #7 (left lower adjacent PE 2c) that is adjacent to the PE #8 (lower adjacent PE 2c) on the upstream side in the row direction.

Furthermore, the output dst1 is connected via the pipeline register 3 and the bus 7R to the input srcL of the right lower adjacent PE 2c that belongs to the same row as the lower adjacent PE 2c and is located on the downstream side in the row direction.

In the example illustrated in FIG. 12, for example, the output dst1 of the PE #5 is connected via the pipeline register 3 and the bus 7R to the input srcL of the PE #9 (right lower adjacent PE 2c) that is adjacent to the PE #8 (lower adjacent PE 2c) on the downstream side in the row direction.

The output dst0 is connected to the input src0 of the PE 2c on the downstream side (the right side in the example illustrated in FIG. 12) in the row direction via the pipeline register 3 and the bus 5.

When the PE #5, for example, is focused on in the example illustrated in FIG. 12, the output dst0 of the PE #5 is connected to the input src0 of the PE #6 (right adjacent PE 2c) via the pipeline register 3 and the bus 5.

Furthermore, the output dst0 is connected via the pipeline register 3 and the bus 7Up to the input srcLo of the right upper adjacent PE 2c that belongs to the same column as the right adjacent PE 2c and is located on the upstream side in the row direction.

In the example illustrated in FIG. 12, for example, the output dst0 of the PE #5 is connected via the pipeline register 3 and the bus 7Up to the input srcLo of the PE #3 (right upper adjacent PE 2c) that is adjacent to the PE #6 (right adjacent PE 2c) on the upstream side in the column direction.

Furthermore, the output dst0 is connected via the pipeline register 3 and the bus 7Lo to the input srcUp of the right lower adjacent PE 2c that belongs to the same column as the right adjacent PE 2c and is located on the downstream side in the column direction.

In the example illustrated in FIG. 12, for example, the output dst0 of the PE #5 is connected via the pipeline register 3 and the bus 7Lo to the input srcUp of the PE #9 (right lower adjacent PE 2c) that is adjacent to the PE #6 (right adjacent PE 2c) on the downstream side in the column direction.

The output dst0 of the PE 2c on the upstream side (the left side in the example illustrated in FIG. 12) in the row direction is connected to the input src0 via the pipeline register 3 and the bus 5.

The output dst1 of the PE 2c on the upstream side (the upper side in the example illustrated in FIG. 12) in the column direction is connected to the input src1 via the pipeline register 3 and the bus 4.

The output dst2 of the PE 2c on the upstream side (the upper side in the example illustrated in FIG. 12) in the column direction is connected to the input src2 via the pipeline register 3 and the bus 4.

The output dstS of the PE 2c on the upstream side (the left side in the example illustrated in FIG. 12) in the row direction is connected to the input srcS via the pipeline register 3 and the bus 5.

The input srcL of host PE 2c is connected via the pipeline register 3 and the bus 7R to the output dst1 of the left upper adjacent PE 2c, which belongs to the same row as upper adjacent PE 2c and located on the upstream side in the row direction The upper adjacent PE 2c is positioned on the upstream side in the column direction relative to the host PE 2c.

In the example illustrated in FIG. 12, for example, the input srcL of the PE #5 is connected via the pipeline register 3 and the bus 7R to the output dst1 of the PE #1 (left upper adjacent PE 2c) that is adjacent to the PE #2 (upper adjacent PE 2c) on the upstream side in the row direction.

The input srcR of host PE 2c is connected via the pipeline register 3 and the bus 7L to the output dst1 of the right upper adjacent PE 2c, which belongs to the same row as the upper adjacent PE 2c and is located on the upstream side in the row direction. The upper adjacent PE 2c is positioned on the downstream side in the column direction relative to the host PE 2c.

In the example illustrated in FIG. 12, for example, the input srcR of the PE #5 is connected via the pipeline register 3 and the bus 7L to the output dst1 of the PE #3 (right upper adjacent PE 2c) that is adjacent to the PE #2 (upper adjacent PE 2c) on the downstream side in the row direction.

The input srcUp of host PE 2c is connected via the pipeline register 3 and the bus 7Lo to the output dst0 of the left upper adjacent PE 2c, which belongs to the same column as the left adjacent PE 2c and is located on the upstream side in the column direction. The left adjacent PE 2c is positioned on the upstream side in the row direction relative to the host PE 2c.

In the example illustrated in FIG. 12, for example, the input srcUp of the PE #5 is connected via the pipeline register 3 and the bus 7Lo to the output dst0 of the PE #1 (left upper adjacent PE 2c) that is adjacent to the PE #4 (left adjacent PE 2c) on the upstream side in the column direction.

The input srcLo of host PE 2c is connected via the pipeline register 3 and the bus 7Up to output dst0 of the left lower adjacent PE 2c, which belongs to the same column as the left adjacent PE 2c and is located on the downstream side in the column direction. The left adjacent PE 2c is positioned on the upstream side in the row direction relative to the host PE 2c.

In the example illustrated in FIG. 12, for example, the input srcLo of the PE #5 is connected via the pipeline register 3 and the bus 7Up to the output dst0 of the PE #7 (left lower adjacent PE 2c) that is adjacent to the PE #4 (left adjacent PE 2c) on the downstream side in the column direction.

The bus 5 is an example of a second bus that connects, to the PE #5 (first processing element), the PE #6 (third processing element) that is adjacent to the PE #5 (first processing element) on the downstream side in a data flow direction in the row direction.

In addition, the bus 7Up is an example of a fifth bus that connects the PE #5 (first processing element) to the PE #3 (sixth processing element) that forms the same column as the PE #6 (third processing element) and is arranged on the side further upstream than the PE #6 (third processing element) in the data flow direction in the column direction.

In addition, the bus 7Lo is an example of a sixth bus that connects the PE #5 (first processing element) to the PE #9 (seventh processing element) that forms the same column as the PE #6 (third processing element) and is arranged on the side further downstream than the PE #6 (third processing element) in the data flow direction in the column direction.

It is possible to state that the buses 4, 5, 7L, 7R, 7Up and 7Lo are connected by the PE controller 8 causing each PE 2c to implement the circuit configuration on the basis of the configuration information stored in the configuration register 9. In other words, the PE controller 8 performs connection among the PEs 2c in the accelerator 1c.

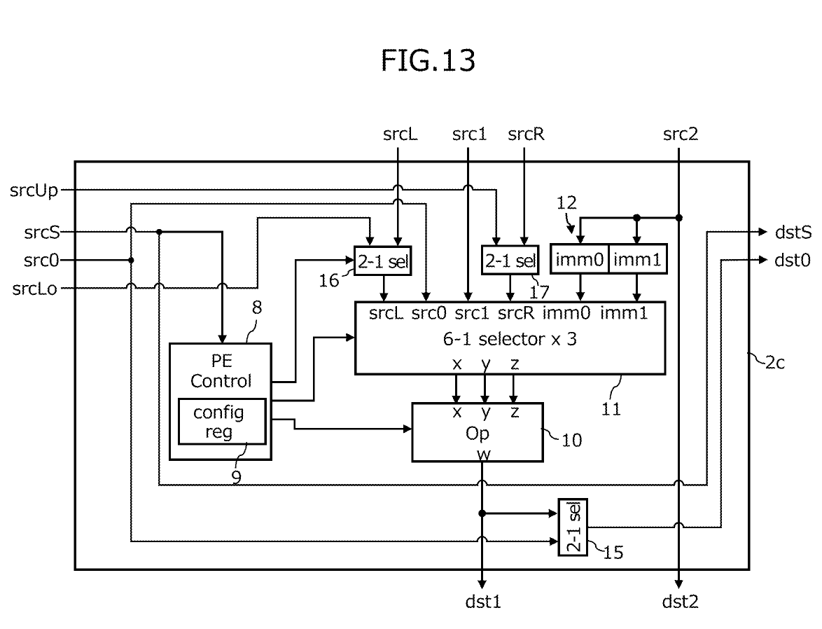

FIG. 13 is a diagram illustrating, as an example, a configuration of each PE 2c in the accelerator 1c according to the second embodiment.

As illustrated in FIG. 13, each PE 2c includes a PE controller 8, a calculation unit 10, selectors 11 and 15 to 17, and an immediate register 12.

srcS input to the PE 2c is input to the PE controller 8 and is output to the downstream PE 2c as dstS. src0 input to the PE 2c is input to the selector 11 and is output to the downstream PE 2c as dst0. src1 input to PE 2c is input to selector 11. src2 input to the PE 2c is input to the immediate register 12 and is output to the downstream PE 2c as dst2.

srcL input to PE 2c is input to selector 16. srcR input to PE 2c is input to selector 17. srcUp input to PE 2c is input to selector 17. srcLo input to PE 2cis input to selector 16.

The immediate register 12 is a register that stores immediate values and has a double-buffer configuration including two storage areas. src2 is input to the immediate register 12. The input src2 may be alternately stored in the two storage areas in the immediate register 12. The two immediate values stored in the immediate register 12 will be represented as imm0 and imm1. Each of imm0 and imm1 is input to the selector 11. Hereinafter, in a case where imm0 and imm1 are not particularly distinguished, imm0 and imm1 will be represented as imm.

The selector 11 is a six-input three-output selector circuit having six inputs and three outputs. The selector 11 may be configured by combining three selector six-input one-output selector circuits (6-1 selectors) each having six inputs and one output. srcL, src0, src1, srcR, imm0, and imm1 are input to the selector 11, and three selected from these six inputs according to control by the PE controller 8 are output. The three outputs of the selector 11 are defined as x, y, and z. Each of the outputs x, y, and z of the selector 11 is input to the calculation unit 10.

The calculation unit 10 performs calculation using the inputs x, y, and z from the selector 11 according to the control by the PE controller 8. In the matrix operation mode, the calculation unit 10 performs fused multiply-add (FMA) operations.

In the CGRA mode, the calculation unit 10 may execute any of FMA, multiplication, addition/subtraction, and bit operations according to the control by the PE controller 8.

A calculation result w obtained by the calculation unit 10 is output as dst1 from the PE 2c and is input to the selector 15.

The selector 16 is a two-input one-output selector circuit having two inputs and one output. srcLo and srcL are input to the selector 16, and one selected out of these two inputs according to control by the PE controller 8 is output. The output of the selector 16 is input to srcL of the selector 11.

The selector 17 is a two-input one-output selector circuit having two inputs and one output. srcUp and srcR are input to the selector 17, and one selected out of these two inputs according to control by the PE controller 8 is output. The output of the selector 17 is input to srcR of the selector 11.

The selector 15 is a two-input one-output selector circuit having two inputs and one output. The output w of the calculation unit 10 and src0 are input to the selector 15, and one selected out of the two inputs according to control by the PE controller 8 is output. The output of the selector 15 is output to the PE 2c on the downstream side as dst0.

It is possible to send the calculation result of the calculation unit 10 to the PE 2c on the downstream side in the row direction by the PE controller 8 switching the selector 15.

Note that illustration of each bus from the PE controller 8 to the selectors 15 to 17 is omitted in FIG. 13 for convenience.

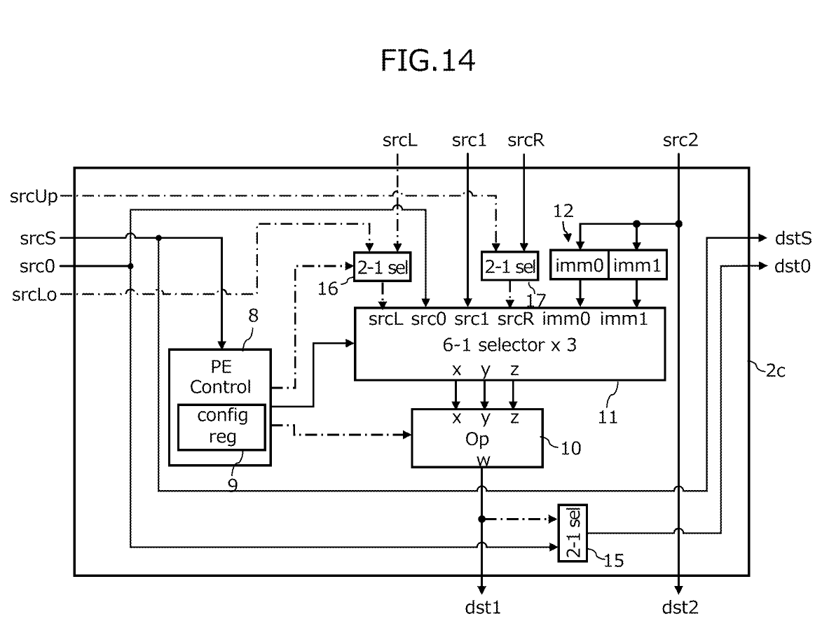

FIG. 14 is a diagram illustrating a bus used in a matrix operation mode in each PE 2c in the accelerator 1c according to the second embodiment. In FIG. 14, the bus used when a matrix product operation is executed in the PE 2c illustrated in FIG. 13 is illustrated by the solid line, and the bus that is not used when the matrix product operation is executed is illustrated by the virtual line (one-dotted chain line).

In the matrix product operation, x is imm0 or imm1. Furthermore, y is src0, and z is src1. The calculation unit 10 calculates w = x × y + z.

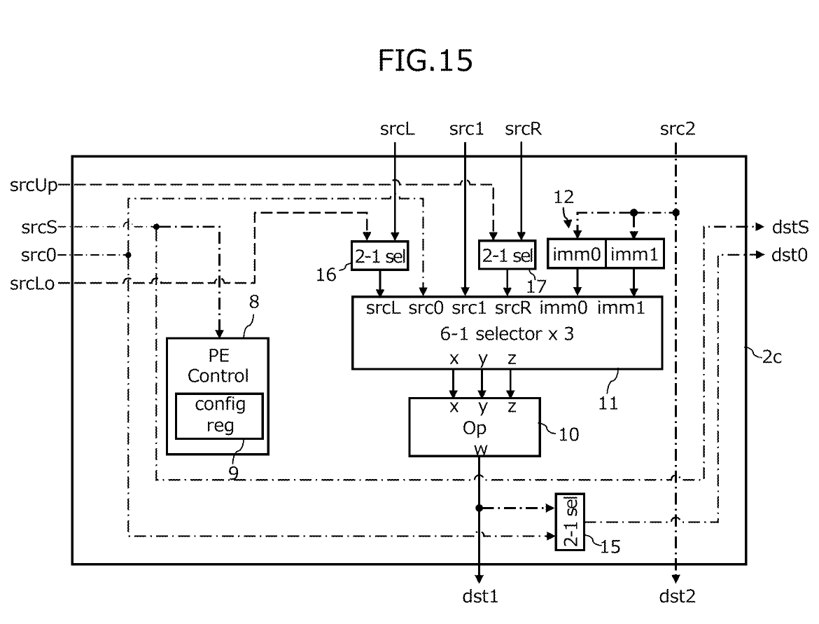

FIG. 15 is a diagram illustrating a bus used in the CGRA vertical mode in the PE 2c in the accelerator 1c according to the second embodiment. In FIG. 15, the bus used when calculation in the CGRA vertical pipeline is executed in the PE 2c illustrated in FIG. 13 is illustrated by the solid line, and the bus that is not used is illustrated by the virtual line (one-dotted chain line).

According to a value stored in the configuration register 9, the selector 16 inputs the value of srcL to the selector 11, and the selector 17 inputs the value of srcR to the selector 11.

In the selector 11, any one of srcL, src1, srcR, imm0, and imm1 designated by a value stored in a predetermined area of the configuration register 9 is selected as each of x, y, z. The calculation unit 10 executes calculation (w = op(x, y, z)) using these x, y, and z.

The calculation result of the calculation unit 10 is output as dst1, and dst1 is input to each of src1 of the lower adjacent PE 2c, srcR of the left lower adjacent PE 2c, and srcL of the right lower adjacent PE 2c.

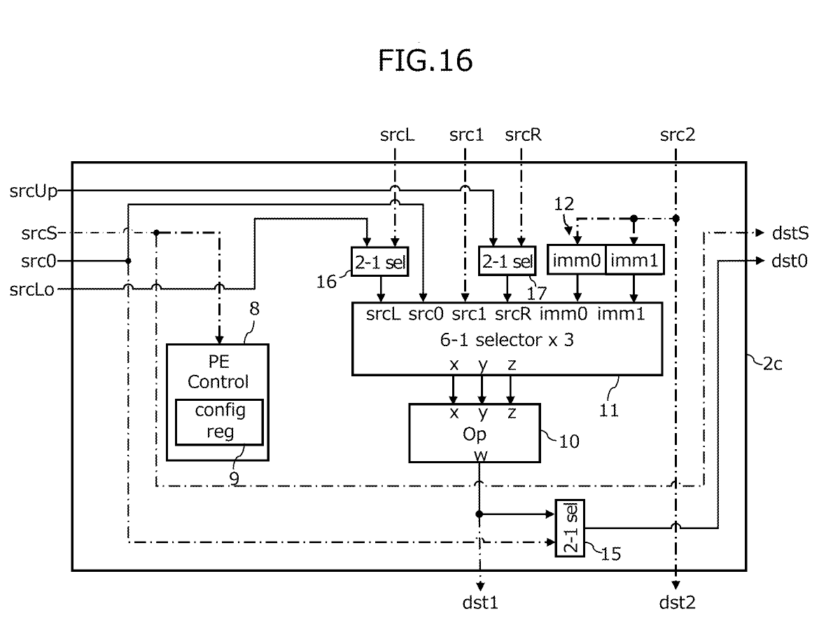

FIG. 16 is a diagram illustrating a bus used in the CGRA lateral mode in the PE 2c in the accelerator 1c according to the second embodiment. In FIG. 16, the bus used when calculation in the CGRA lateral pipeline is executed in the PE 2c illustrated in FIG. 13 is illustrated by the solid line, and the bus that is not used is illustrated by the virtual line (one-dotted chain line).

According to a value stored in the configuration register 9, the selector 16 inputs the value of srcLo to the selector 11, and the selector 17 inputs the value of srcUp to the selector 11.

In the selector 11, any one of srcUp, src0, srcLo, imm0, and imm1 designated by a value stored in a predetermined area of the configuration register 9 is selected as each of x, y, z. The calculation unit 10 executes calculation (w = op(x, y, z)) using these x, y, and z.

According to the value stored in the configuration register 9, the selector 15 causes the calculation result w of the calculation unit 10 to be output as dst0. dst0 is input to each of src0 of the right adjacent PE 2c, srcLo of the right upper adjacent PE 2c, and srcUp of the right lower adjacent PE 2c.

In other words, in a case where the accelerator 1c is used for the second non-matrix operation (CGRA lateral mode), data is transmitted among the plurality of PEs 2c using the bus 7Up (fifth bus) and the bus 7Lo (sixth bus). Data transmitted among the plurality of PEs 2c via the bus 7Up (fifth bus) and the bus 7Lo (sixth bus) is used for the second non-matrix operation.

### (C) Actions and Effects

In a case where the accelerator 1c according to the second embodiment configured as described above is caused to execute calculation, a host computer transmits configuration information in accordance with the calculation (calculation mode) to be executed to the accelerator 1c via the configuration path.

In each PE 2c, the configuration information received via the configuration path is stored in the configuration register 9 of the PE controller 8. In each PE 2c, circuit (see FIG. 13) reconfiguration for performing calculation is performed on the basis of the configuration information stored in the configuration register 9.

In the matrix operation mode, the accelerator 1c executes the matrix operation similarly to the accelerator 1a of the first embodiment.

In the CGRA vertical mode, the pipelined CGRA is realized in the column direction, and similarly to the accelerator 1a of the first embodiment, the non-matrix operation (FMA, multiplication, addition/subtraction, a bit operation, or the like) is executed by sending data and the like in the column direction among the PEs 2c in the PE group of the accelerator 1c.

Furthermore, in the CGRA lateral mode, the pipelined CGRA in the row direction is realized, and the non-matrix operation (FMA, multiplication, addition/subtraction, a bit operation, or the like) is executed by sending data and the like in the row direction among the PEs 2c in the PE group of the accelerator 1c.

In each PE2c, the operation in the CGRA vertical mode and the operation in the CGRA lateral mode are switched by switching the selectors 11 and 15 to 17 according to the value stored in the predetermined area of the configuration register 9.

In the PE group of the accelerator 1c of the second embodiment, high-functionality PEs are used, in at least one row, as two or more PEs 2c that belong to the row from among the plurality of PEs 2c constituting the PE group. The high-functionality PEs are PEs 2c having higher functionality than the other PEs 2c in the PE group. It is possible to efficiently perform data processing in the AI by causing such an accelerator 1c to function in the CGRA vertical mode. It is possible to efficiently perform data processing in HPC by causing the accelerator 1c to function in the CGRA lateral mode.

As described above, in the accelerator 1c of the second embodiment, it is possible to obtain the same actions and effects as those of the accelerator 1a of the first embodiment, and it is also possible to selectively switch and execute the vertical pipeline and the lateral pipeline in accordance with an application or the like and to thereby efficiently utilize the accelerator 1c in accordance with characteristics of the application. In other words, it is possible to efficiently take advantage of the high-functionality PEs that are partially mounted by the accelerator 1c being able to switch and execute both the pipeline operation from top to bottom in the column direction and the pipeline operation from left to right in the row direction.

### (IV) Description of Modification of Second Embodiment

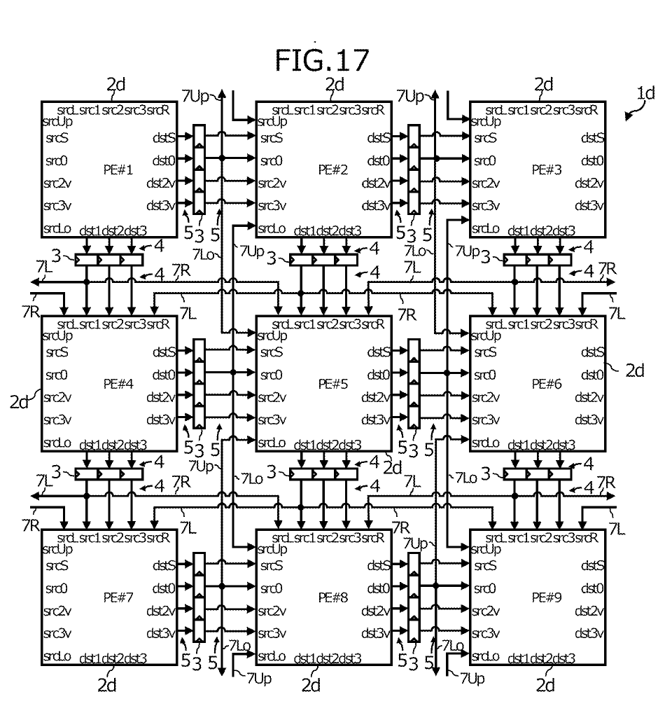

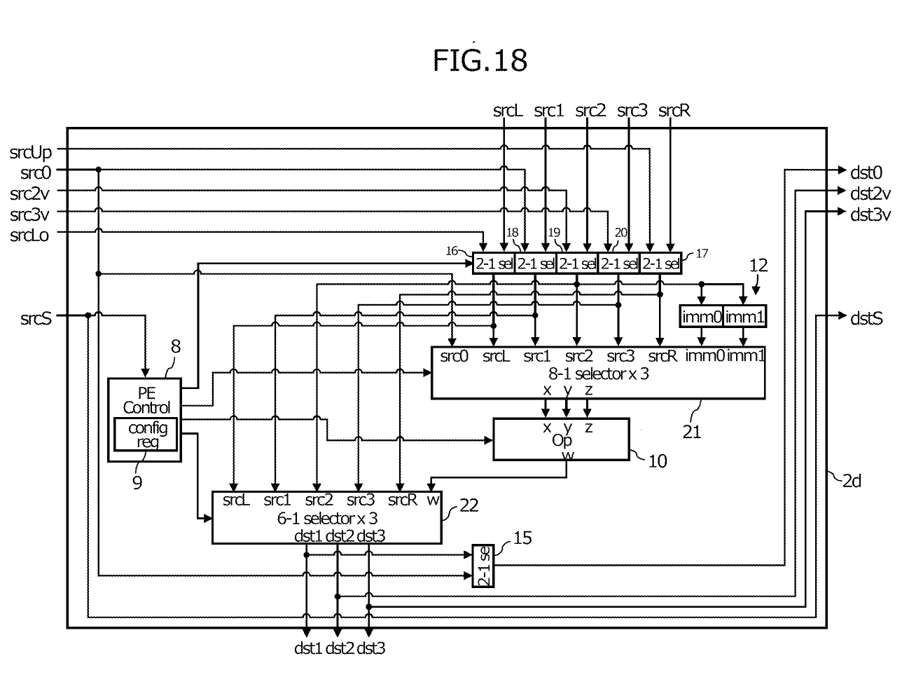

FIGS. 17 and 18 are diagrams for explaining a configuration of an accelerator 1d as a modification of the second embodiment. FIG. 17 is a diagram illustrating, as an example, a connection configuration among PEs 2d in the accelerator 1d as the modification of the second embodiment, and FIG. 18 is a diagram illustrating, as an example, a configuration of each PE 2d in the accelerator 1d as the modification of the second embodiment.

In the accelerator 1d illustrated as an example in FIG. 17, wirings (paths) of src2v, src3v, dst2v, and dst3v are added in addition to the connection configuration of the accelerator 1a of the second embodiment illustrated in FIG. 12.

The output dst2v is connected to the input src2v of the PE 2d (right adjacent PE 2d) on the downstream side (the right side in the example illustrated in FIG. 17) in the row direction via a pipeline register 3 and a bus 5. The output dst3v is connected to the input src3v of the PE 2d (right adjacent PE 2d) on the downstream side (the right side in the example illustrated in FIG. 17) in the row direction via the pipeline register 3 and the bus 5.

The output dst2v of the PE 2d (left adjacent PE 2d) on the upstream side (the left side in the example illustrated in FIG. 17) in the row direction is connected to the input src2v via the pipeline register 3 and the bus 5. The output dst3v of the PE 2d (left adjacent PE 2d) on the upstream side (the left side in the example illustrated in FIG. 17) in the row direction is connected to the input src3v via the pipeline register 3 and the bus 5.

As illustrated in FIG. 18, each PE 2d includes a PE controller 8, a calculation unit 10, selectors 15 to 22, and an immediate register 12.

srcS input to the PE 2d is input to the PE controller 8 and is output to the downstream PE 2d as dstS.

src0 input to the PE 2d is input to each of the selectors 15, 18, and 21. srcL input to PE 2d is input to selector 16. src1 input to PE 2d is input to selector 18. src2 input to PE 2d is input to selector 19.

Also, src3 input to PE 2d is input to selector 20. srcR input to PE 2d is input to selector 17. srcUp input to PE 2d is input to selector 17. srcLo input to PE 2d is input to selector 16. Furthermore, src2v input to PE 2d is input to the selector 19, and src3v input to PE 2d is input to the selector 20.

Each of the selectors 15 to 20 is a two-input one-output selector circuit having two inputs and one output.

srcLo and srcL are input to the selector 16, and one selected out of these two inputs according to control by the PE controller 8 is output. The output of the selector 16 is input to src0 of the selector 21.

src0 and src1 are input to the selector 18, and one selected out of these two inputs according to control by the PE controller 8 is output. The output of the selector 18 is input to src1 of the selector 21.

src2v and src2 are input to the selector 19, and one selected out of these two inputs according to control by the PE controller 8 is output. The output of selector 19 is input to src2 of the selector 21, src2 of the selector 22, and the immediate register 12. The output of the selector 19 is stored as immediate values imm0 and imm1 in the immediate register 12.

src3v and src3 are input to the selector 20, and one selected out of these two inputs according to control by the PE controller 8 is output. The output of the selector 20 is input to src3 of the selector 21.

The selector 21 is an eight-input three-output selector circuit having eight inputs and three outputs. The selector 21 may be configured by combining three eight-input one-output selector circuits (8-1 selectors) each having eight inputs and one output. srcL, src0, src1, src2, src3, srcR, imm0, and imm1 are input to the selector 21, and three selected from these eight inputs according to control by the PE controller 8 are output. The three outputs of the selector 21 are defined as x, y, and z. Each of the outputs x, y, and z of the selector 21 is input to the calculation unit 10.

The calculation unit 10 performs calculation using the inputs x, y, and z from the selector 11 according to the control by the PE controller 8. In the matrix operation mode, the calculation unit 10 performs an FMA operation. In the CGRA mode, the calculation unit 10 may execute any of FMA, multiplication, addition/subtraction, and bit operations according to the control by the PE controller 8. A calculation result w of the calculation unit 10 is input to the selector 22.

The selector 22 is a six-input three-output selector circuit having six inputs and three outputs. The selector 22 may be configured by combining three six inputs one-output selector circuits (6-1 selectors) having six inputs and one output. srcL, src1, src2, src3, srcR, and the output w of the calculation unit 10 are input to the selector 22, and three selected from these six inputs according to control by the PE controller 8 are output. The three outputs of the selector 22 are defined as dst1, dst2, and dst3. Each of the outputs dst1, dst2, and dst3 of the selector 22 is output from the PE 2d. In addition, dst1 is also input to the selector 15.

In the accelerator 1d illustrated as an example in FIG. 18, dst1 out of these outputs dst1, dst2, and dst3 is input to, in addition to the lower adjacent PE 2d, the left lower adjacent PE 2d and the right lower adjacent PE 2d in the CGRA vertical mode.

src0 and dst1 are input to the selector 15, and one selected out of these two inputs according to control by the PE controller 8 is output. The output dst0 of the selector 15 is output from the PE 2d. dst0 is input to each of src0 of the right adjacent PE 2d, srcLo of the right upper adjacent PE 2d, and srcUp of the right lower adjacent PE 2d in the CGRA lateral mode.

As described above, according to the accelerator 1d as the modification of the second embodiment configured as described above, it is possible to obtain the same actions and effects as those in the second embodiment and to take advantage of the src2, dst2, src3, and dst3 buses as data transfer paths in the CGRA vertical mode. Also, it is possible to take advantage of the src2v, dst2v, src3v, and dst3v buses as data transfer paths in the CGRA lateral mode as well.

In addition, it is possible to further increase the data transfer paths (transfer paths) by adding the src2v, src3v, dst2v, and dst3v buses.

As a result, it is possible to widen the mappable applications and to achieve an effect that automatic mapping by a compiler is facilitated.

### (V) Others

Each configuration and each process of each embodiment and each modification can be chosen as needed or may be appropriately combined.

The disclosed technology is not limited to the above-described embodiments, and can be variously modified and implemented without departing from the gist of each embodiment and each modification.

Although the example in which dst1 is input to the left lower adjacent PEs 2a, 2b, 2c, and 2d and the right lower adjacent PEs 2a, 2b, 2c, and 2d in the CGRA mode (CGRA vertical mode) has been described in each of the above-described embodiments and modifications, the present disclosure is not limited thereto.

dst1 may be input to the PEs 2a, 2b, 2c, and 2d that belong to the same row as the lower adjacent PEs 2a, 2b, 2c, and 2d and are not adjacent to the lower adjacent PEs 2a, 2b, 2c, and 2d.

In other words, dst1 may be input to the PEs 2a, 2b, 2c, and 2d that belong to the same row as the lower adjacent PEs 2a, 2b, 2c, and 2d, other than the lower adjacent PEs 2a, 2b, 2c, and 2d.

Although dst1 is input to, in addition to the lower adjacent PEs 2a, 2b, 2c, and 2d, the left lower adjacent PEs 2a, 2b, 2c, and 2d and the right lower adjacent PEs 2a, 2b, 2c, and 2d in the CGRA mode (CGRA vertical mode) in each of the above-described embodiments and modifications, the present disclosure is not limited thereto.

At least one or of dst1, dst2, and dst3 may be input to the PEs 2a, 2b, 2c, and 2d, other than the lower adjacent PEs 2a, 2b, 2c, and 2d, that belong to the same row as the lower adjacent PEs 2a, 2b, 2c, and 2d.

Although the example in which dst0 is input to the right upper adjacent PEs 2c and 2d and the right lower adjacent PEs 2c and 2d, which are adjacent to the right adjacent PEs 2c and 2d, in the CGRA lateral mode has been described in the above-described second embodiment and the modification thereof, the present disclosure is not limited thereto.

dst0 may be input to the PEs 2c and 2d that belong to the same column as the right adjacent PEs 2c and 2d and are not adjacent to the right adjacent PEs 2c and 2d.

In other words, dst0 may be input to the PEs 2c and 2d that belong to the same column as the right adjacent PEs 2c and 2d, other than the right adjacent PEs 2c and 2d.

Although dst0 is input to, in addition to the right adjacent PE 2d, the right upper adjacent PE 2d and the right lower adjacent PE 2d in the CGRA lateral mode in the above-described modification of the second embodiment, the present disclosure is not limited thereto.

At least one or more of dst0, dst2v, and dst3v may be input to the PEs 2d that belong to the same column as the right adjacent PE 2d other than the right adjacent PE 2d.

According to an embodiment, both matrix and non-matrix operations can be accelerated.

Throughout the descriptions, the indefinite article "a" or "an" does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An arithmetic circuit comprising:
a plurality of processing elements that are arranged in a lattice pattern;
a first bus that connects, to a first processing element from among the plurality of processing elements, a second processing element that is adjacent to the first processing element on a downstream side in a data flow direction in a column direction;
a second bus that connects a third processing element that is adjacent to the first processing element on a downstream side in a data flow direction in a row direction to the first processing element;
a third bus that connects a fourth processing element that forms a same row as the second processing element and is arranged on a side further upstream than the second processing element in the data flow direction in the row direction to the first processing element; and
a fourth bus that connects a fifth processing element that forms a same row as the second processing element and is arranged on a side further downstream than the second processing element in the data flow direction in the row direction to the first processing element.

2. The arithmetic circuit according to claim 1, wherein
data transmitted among the plurality of processing elements via the first bus and the second bus is used for a matrix operation in the arithmetic circuit, and
data transmitted among the plurality of processing elements via the first bus, the third bus, and the fourth bus is used for a first non-matrix operation in the arithmetic circuit.

3. The arithmetic circuit according to claim 1, comprising:
a fifth bus that connects a sixth processing element that forms a same column as the third processing element and is arranged on a side further upstream than the third processing element in the data flow direction in the column direction to the first processing element; and
a sixth bus that connects a seventh processing element that forms a same column as the third processing element and is arranged on a side further downstream than the third processing element in the data flow direction in the column direction to the first processing element.

4. The arithmetic circuit according to claim 3, wherein
data transmitted among the plurality of processing elements via the second bus, the fifth bus, and the sixth bus is used for a non-matrix operation in the arithmetic circuit.

5. The arithmetic circuit according to claim 3, wherein
two or more processing elements arranged continuously either in a row direction or in a column direction from among the plurality of processing elements arranged in the lattice pattern are high-functionality processing elements with higher functionality than the other processing elements.

6. An arithmetic method of an arithmetic circuit including:
a plurality of processing elements that are arranged in a lattice pattern;
a first bus that connects, to a first processing element from among the plurality of processing elements, a second processing element that is adjacent to the first processing element on a downstream side in a data flow direction in a column direction;
a second bus that connects a third processing element that is adjacent to the first processing element on a downstream side in a data flow direction in a row direction to the first processing element;
a third bus that connects a fourth processing element that forms a same row as the second processing element and is arranged on a side further upstream than the second processing element in the data flow direction in the row direction to the first processing element; and
a fourth bus that connects a fifth processing element that forms a same row as the second processing element and is arranged on a side further downstream than the second processing element in the data flow direction in the row direction to the first processing element,
the method comprising, by each of the plurality of processing elements:
using data transmitted among the plurality of processing elements via the first bus and the second bus for a matrix operation; and
using data transmitted among the plurality of processing elements via the first bus, the third bus, and the fourth bus for a first non-matrix operation in the arithmetic circuit.

7. The arithmetic method according to claim 6, wherein
the arithmetic circuit includes
a fifth bus that connects a sixth processing element that forms a same column as the third processing element and is arranged on a side further upstream than the third processing element in the data flow direction in the column direction to the first processing element, and
a sixth bus that connects a seventh processing element that forms a same column as the third processing element and is arranged on a side further downstream than the third processing element in the data flow direction in the column direction to the first processing element, and
each of the plurality of processing elements uses data transmitted among the plurality of processing elements via the second bus, the fifth bus, and the sixth bus for a non-matrix operation.

8. The arithmetic method according to claim 7, wherein
two or more processing elements arranged continuously either in a row direction or in a column direction from among the plurality of processing elements arranged in the lattice pattern are high-functionality processing elements with higher functionality than the other processing elements.

9. A method of connecting a processing element in an arithmetic circuit including a plurality of processing elements that are arranged in a lattice pattern, the method comprising:
connecting, to a first processing element from among the plurality of processing elements, a second processing element that is adjacent to the first processing element on a downstream side in a data flow direction in a column direction with a first bus;
connecting a third processing element that is adjacent to the first processing element on a downstream side in a data flow direction in a row direction to the first processing element with a second bus;
connecting a fourth processing element that forms a same row as the second processing element and is arranged on a side further upstream than the second processing element in the data flow direction in the row direction to the first processing element with a third bus; and
connecting a fifth processing element that forms a same row as the second processing element and is arranged on a side further downstream than the second processing element in the data flow direction in the row direction to the first processing element with a fourth bus.

10. The method of connecting a processing element in an arithmetic circuit according to claim 9, wherein
data transmitted among the plurality of processing elements via the first bus and the second bus is used for a matrix operation in the arithmetic circuit, and
data transmitted among the plurality of processing elements via the first bus, the third bus, and the fourth bus is used for a first non-matrix operation in the arithmetic circuit.

11. The method of connecting a processing element in an arithmetic circuit according to claim 9, comprising:
connecting a sixth processing element that forms a same column as the third processing element and is arranged on a side further upstream than the third processing element in the data flow direction in the column direction to the first processing element with a fifth bus; and
connecting a seventh processing element that forms a same column as the third processing element and is arranged on a side further downstream than the third processing element in the data flow direction in the column direction to the first processing element with a sixth bus.

12. The method of connecting a processing element in an arithmetic circuit according to claim 11, wherein
data transmitted among the plurality of processing elements via the second bus, the fifth bus, and the sixth bus is used for a non-matrix operation in the arithmetic circuit.

13. The method of connecting a processing element in an arithmetic circuit according to claim 11, wherein
two or more processing elements arranged continuously either in a row direction or in a column direction from among the plurality of processing elements arranged in the lattice pattern are high-functionality processing elements with higher functionality than the other processing elements.
